(19) United States
(12) Patent Application Publication
(10) Pub. No.: US 2008/0077878 A1
(43) Pub. Date: Mar. 27, 2008

(54) Information communication device

(75) Inventor: Kei Koitabashi, Tokyo (JP)

Correspondence Address: TAKEUCHI & KUBOTERA, LLP, SUITE 202, 200 DAINGERFIELD ROAD, ALEXANDRIA, VA, 22314, US

(73) Assignee: Oki Data Corporation

(21) Appl. No.: 11/898,413

(22) Filed: Sep. 12, 2007

(30) Foreign Application Priority Data
Sep. 22, 2006 (JP) 2006-257292

(51) Int. Cl. G06F 3/048

(52) U.S. Cl. 715/781

(57) ABSTRACT

An information communication device includes a reading unit for reading information of an original; a display input unit for displaying a transmission destination setting screen to transmit the information, and for prompting an operator to input destination data indicating a transmission destination; and a transmission unit for transmitting the information externally according to the destination data. Further, the display input unit displays the destination data on the transmission destination setting screen after the transmission unit transmits the information.

### BACKGROUND OF THE INVENTION

The present invention relates to an information communication device. More specifically, the present invention relates to an information communication device having multiple functions for transmitting information through an electronic mail.

An information communication device includes a multi-function printer (MFP) having multiple functions of a copier, a facsimile, and a scanner. The information communication device is provided with a copier unit, a facsimile unit, a printer unit, and a scanner unit for achieving the multiple functions.

When an operator selects to transmit an electrical mail using the scanner unit, the operator inputs a mail address through a transmission destination setting screen displayed on the scanner unit according to a selection of the operator. Then, the operator places an original on the scanner unit for scanning the original to read an image, a text, and the likes thereof. Lastly, the scanner unit transmits the image and the text thus read to an external device through a communication line according to the mail address thus input (refer to Patent Reference).

Patent Reference: Japanese Patent Publication No. 2000-134402

In the conventional information communication device, each time when the operator sends an electrical mail, the operator needs to input a mail address after the transmission destination setting screen is displayed. After transmitting the electrical mail, the mail address is deleted. Accordingly, even when several mails are sent to a same destination, it is necessary to input a mail address for each of the mails. In other wards, when several mails are sent to a same destination in several occasions, it is necessary to input the same destination for each of the occasions. As a result, it is necessary for the operator to input the destination repeatedly, thereby taking a long period of time for completing the job.

In view of the problems described above, an object of the invention is to provide an information communication device, in which, it is possible to transmit information in a short period of time.

Further objects and advantages of the invention will be apparent from the following description of the invention.

### SUMMARY OF THE INVENTION

In order to attain the objects described above, according to a first aspect of the present invention, an information communication device includes a reading unit for reading information of an original; a display input unit for displaying a transmission destination setting screen to transmit the information, and for prompting an operator to input destination data indicating a transmission destination; and a transmission unit for transmitting the information externally according to the destination data. Further, the display input unit displays the destination data on the transmission destination setting screen after the transmission unit transmits the information.

According to a second aspect of the present invention, the information communication device may further include a destination data registration unit for storing the destination data; and a destination book control unit for reading the destination data registered in the destination data registration unit and displaying the destination data on the display input unit as a destination book.

According to a third aspect of the present invention, the information communication device may further include a destination data registration unit for storing the destination data; and a symbol control unit for displaying a symbol screen including various symbols on the display input unit. Accordingly, an operator can select a symbol from the symbol screen upon inputting the destination data.

According to a fourth aspect of the present invention, the information communication device may further include a comparison determination control unit for comparing the destination data input through selecting the symbol with the destination data registered in the destination data registration unit. When the comparison determination control unit determines that the destination data input through selecting the symbol are different from the destination data registered in the destination data registration unit, the comparison determination control unit registers the destination data registered in the destination data registration unit.

According to a fifth aspect of the present invention, the information communication device may further include a temporary storage unit for temporarily storing the destination data thus input, and a deletion unit for deleting the destination data temporarily stored in the temporary storage unit when the comparison determination control unit determines that the destination data input through selecting the symbol are same as the destination data registered in the destination data registration unit.

According to a sixth aspect of the present invention, the information communication device may further include a monitoring determination unit for monitoring a transmission completion state of the transmission unit and determining whether the transmission completion state is normal or abnormal.

According to a seventh aspect of the present invention, the information communication device may further include a comparison determination control unit for comparing the destination data input through selecting the symbol with the destination data registered in the destination data registration unit when the monitoring determination unit determines that the transmission completion state is normal. When the comparison determination control unit determines that the destination data input through selecting the symbol are different from the destination data registered in the destination data registration unit, the comparison determination control unit registers the destination data registered in the destination data registration unit.

According to an eighth aspect of the present invention, the information communication device may further include a temporary storage unit for temporarily storing the destination data thus input, and a deletion unit for deleting the destination data temporarily stored in the temporary storage unit when the comparison determination control unit determines that the destination data input through selecting the symbol are same as the destination data registered in the destination data registration unit.

According to a ninth aspect of the present invention, the information communication device may further include a temporary storage unit for temporarily storing the destination data thus input, and a deletion unit for deleting the destination data temporarily stored in the temporary storage unit when the monitoring determination unit determines that the transmission completion state is abnormal.

According to a tenth aspect of the present invention, the symbol may include a text and a graphic, and the symbol screen may include a keyboard display input screen.

According to an eleventh aspect of the present invention, the transmission destination setting screen may include a mail address input screen, and the destination data may include a mail address.

In the information communication device of the present invention, after the transmission unit transmits the information, it is determined whether a plurality of subsequent transmissions is performed to a same transmission destination. When a plurality of subsequent transmissions is performed to a same transmission destination, the destination data remain on the screen to use for a next operation. Accordingly, it is possible to perform several transmissions through one input, thereby reducing input workload of the operator and an input time. Further, when a plurality of subsequent transmissions is not performed, the destination data are deleted from the screen, thereby preventing the destination data from leaking.

### BRIEF DESCRIPTION OF THE DRAWINGS

FIG. 1 is a block diagram showing an information communication device according to a first embodiment of the present invention;

FIG. 2 is a flow chart showing an operation of the information communication device according to the first embodiment of the present invention;

FIG. 3 is a schematic view showing an example of a mail address input screen according to the first embodiment of the present invention;

FIG. 4 is a schematic view showing a destination data registration unit according to the first embodiment of the present invention;

FIG. 5 is a schematic view showing a book input screen according to the first embodiment of the present invention;

FIG. 6 is a schematic view showing a keyboard display input screen according to the first embodiment of the present invention;

FIG. 7 is a schematic view showing the mail address input screen in a state that a mail address is input according to the first embodiment of the present invention;

FIG. 8 is a schematic view showing a subsequent transmission confirmation screen according to the first embodiment of the present invention;

FIG. 9 is a block diagram showing an information communication device according to a second embodiment of the present invention;

FIG. 10 is a flow chart showing an operation of the information communication device according to the second embodiment of the present invention;

FIG. 11 is a block diagram showing an information communication device according to a third embodiment of the present invention; and

FIG. 12 is a flow chart showing an operation of the information communication device according to the third embodiment of the present invention.

### DESCRIPTION OF THE PREFERRED EMBODIMENTS

Hereunder, embodiments of the present invention will be explained with reference to the accompanying drawings. In the description below, a color printer is described as an example of an information communication device.

### First Embodiment

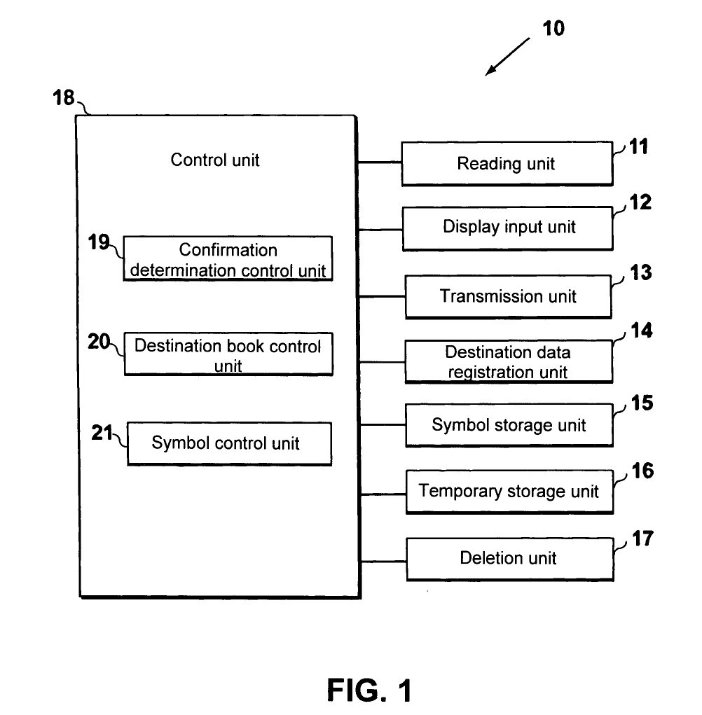

A first embodiment of the present invention will be explained. FIG. 1 is a block diagram showing an information communication device 10 according to the first embodiment of the present invention.

As shown in FIG. 1, the information communication device 10 includes a reading unit 11; a display input unit 12; a transmission unit 13; a destination data registration unit 14; a symbol storage unit 15; a temporary storage unit 16; a deletion unit 17; and a control unit 18 for controlling the units described above.

In the embodiment, the information communication device 10 is a multi-function printer (MFP). In the information communication device 10, a scanner unit is formed of the reading unit 11; the display input unit 12; the transmission unit 13; the destination data registration unit 14; the symbol storage unit 15; the temporary storage unit 16; the deletion unit 17; and the control unit 18. The information communication device 10 is connected to an external device (not illustrated) and performs communication with the external device via a communication line (not illustrated).

In the embodiment, the reading unit 11 has a function of scanning a document and reading information such as an image and a text from the document. The display input unit 12 has a function of displaying a screen such as a transmission destination setting screen, so that an operator can enter data such as destination data. The transmission unit 13 has a function of sending the information read by the reading unit 11 to the external device according to the destination data.

In the embodiment, the destination data registration unit 14 has a function of registering in advance the destination data indicating a destination of information. The symbol storage unit 15 has a function of storing symbols such as letters, graphics, and symbols for the operator to enter the destination data upon sending information. The temporary storage unit 16 has a function of temporarily storing the destination data thus entered using the symbols. The deletion unit 17 includes a function of deleting the destination data from the temporary storage unit 16.

In the embodiment, the control unit 18 includes a confirmation determination control unit 19; a destination book control unit 20; a symbol control unit 21, and a control program for controlling the reading unit 11; the display input unit 12; the transmission unit 13; the destination data registration unit 14; the symbol storage unit 15; the temporary storage unit 16; and the deletion unit 17.

In the embodiment, the confirmation determination control unit 19 has a function of displaying a subsequent transmission confirmation screen on the display input unit 12, so that the operator can confirm whether there is a subsequent transmission to the same destination after the transmission unit 13 completes the transmission. When the operator confirms that there is a subsequent transmission to the same destination, the destination data remains on the transmission destination setting screen. When the operator confirms that there is no subsequent transmission to the same destination, the destination data is deleted from the transmission destination setting screen.

In the embodiment, the destination book control unit 20 has a function of reading the destination data already registered in the destination data registration unit 14, and displaying the destination data on the display input unit 12 as a destination book. Accordingly, the operator can select and enter the destination data from the destination book. The symbol control unit 21 has a function of retrieving the symbols from the symbol storage unit 15 and displaying a symbol screen containing the symbols on the display input unit 12. The symbol screen may include a soft keyboard. The operator can select the symbols through the soft keyboard to enter the destination data.

An operation of the information communication device 10 will be described next. In the embodiment, the transmission destination setting screen is a mail address input screen; the destination data are mail addresses; and the destination book is an address book.

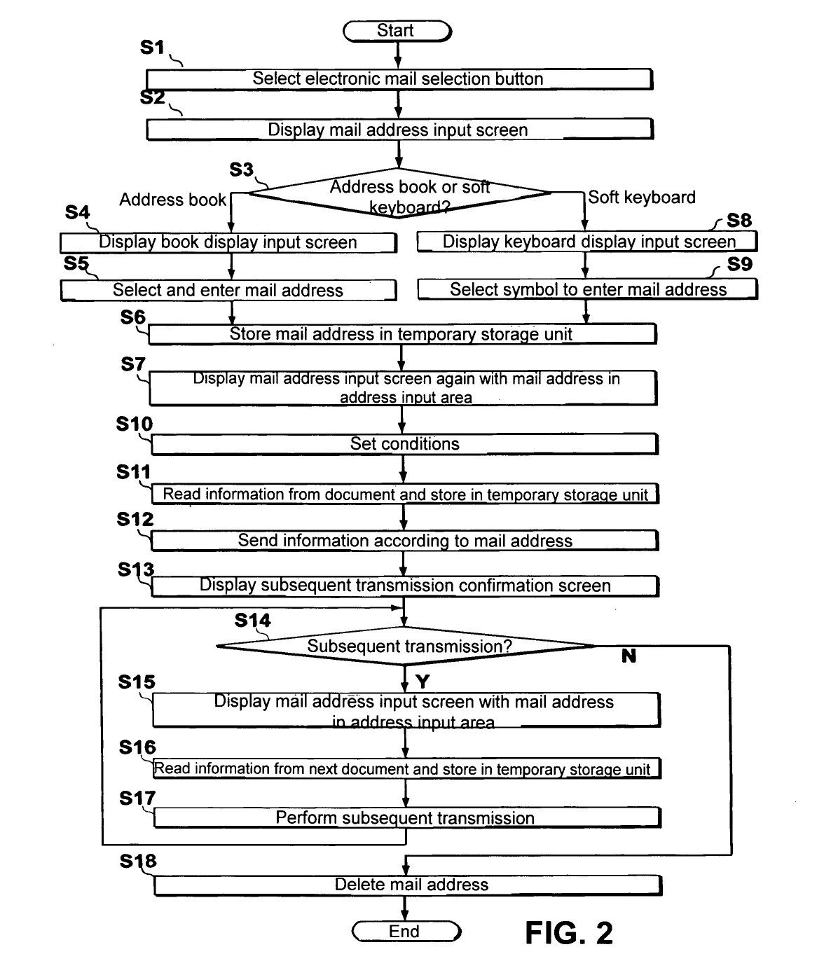

FIG. 2 is a flow chart showing the operation of the information communication device 10 according to the first embodiment of the present invention.

In step S1, the operator selects an electronic mail selection button “Scan To Email” provided in the information communication device 10 to send an electronic mail. In step S2, the control unit 18 starts the control program, and controls the display input unit 12 to display a mail address input screen according to the selection of the operator.

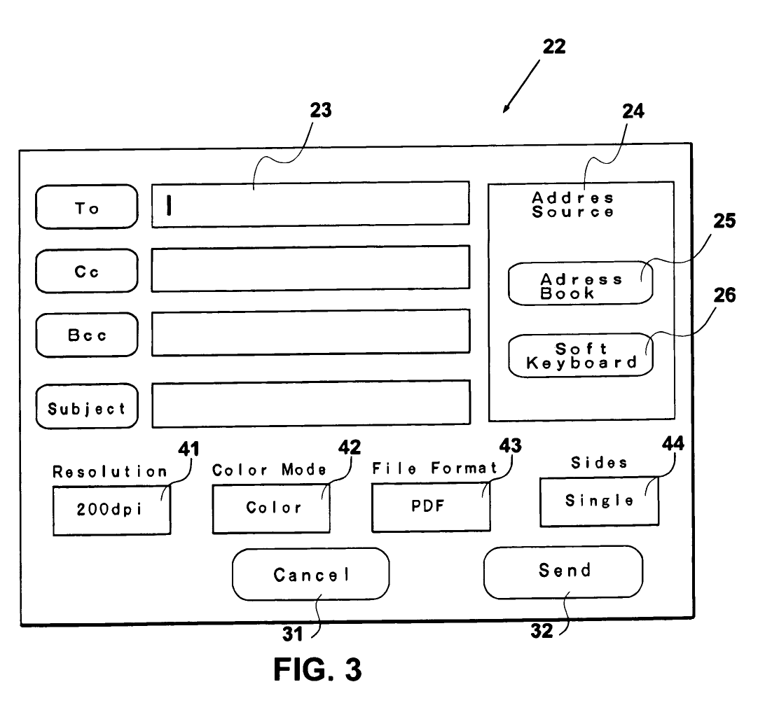

FIG. 3 is a schematic view showing an example of the mail address input screen 22 according to the first embodiment of the present invention. As shown in FIG. 3, the mail address input screen 22 has an address input area 23 for entering an e-mail address. Further, the mail address input screen 22 has an address source area 24 to enable the operator to enter an e-mail address therein. Still further, the mail address input screen 22 has a “Cancel” button 31 to cancel transmission of information, and a “Send” button 32 to transmit information.

In the embodiment, the address source area 24 has a book selection key 25 to display the address book comprised of mail addresses registered in the destination data registration unit 14 in advance, and a symbol selection key 26 to display the soft keyboard having the symbols stored in the symbol storage unit 15.

In the embodiment, the mail address input screen 22 has a resolution setting area (Resolution) 41 to set a resolution; a color mode setting area (Color Mode) 42 to choose a color mode between color and monochrome; a file formatting area 43 to set a format of a file; and a side setting region (Sides) 44 to set a reading surface (one side or two sides).

In step S2, the operator enters a mail address in the address input area 23 using the address book or the soft keyboard. The display input unit 12 displays the mail address input screen 22 for setting a condition such as the resolution of the file to be sent.

In step S3, the operator selects the book selection key 25. In step S4, the destination book control unit 20 reads the mail addresses registered in the destination data registration unit 14, and displays the mail addresses on the display input unit 12 as the address book.

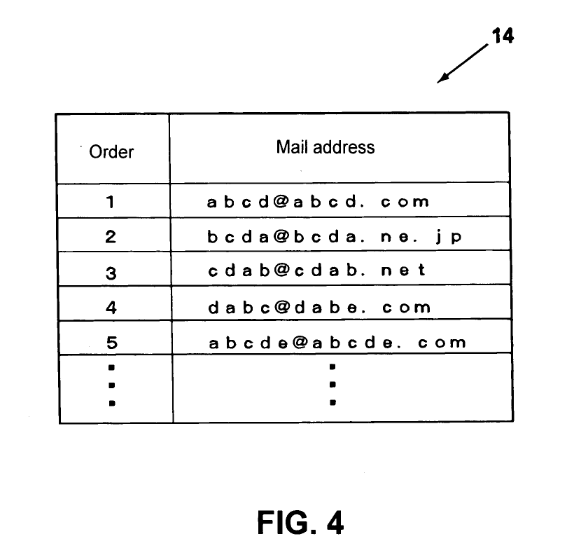

FIG. 4 is a schematic view showing the destination data registration unit 14 according to the first embodiment of the present invention. As shown in FIG. 4, the mail addresses are registered in the destination data registration unit 14.

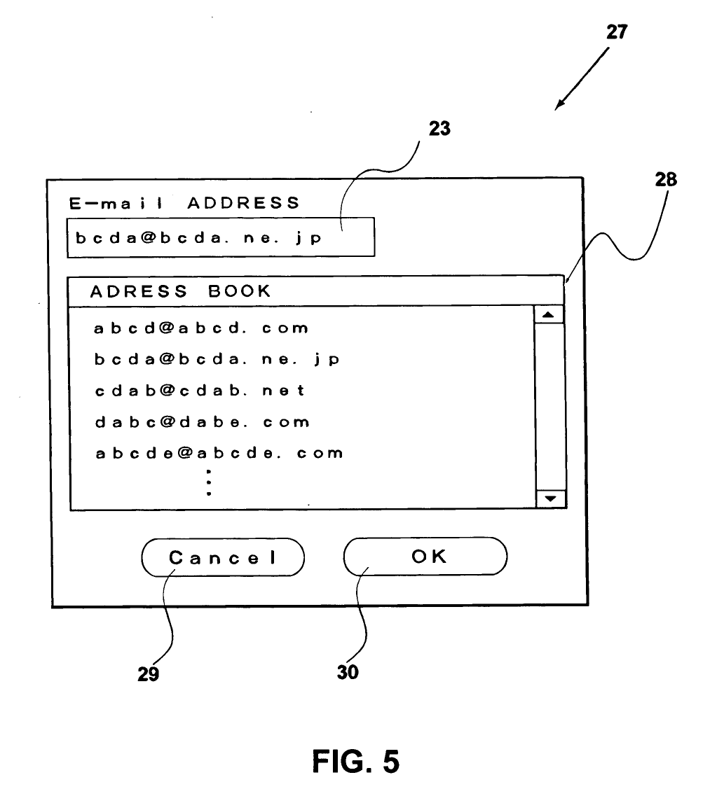

FIG. 5 is a schematic view showing a book display input screen 27 according to the first embodiment of the present invention. As shown in FIG. 5, the book display input screen 27 has the address input area 23 and the address book area 28. In the address book area 28, the address book containing the mail addresses read from the destination data registration unit 14 is displayed. Further, the book display input screen 27 has a “Cancel” button 29 to make a correction or so in the mail addresses and an “OK” button 30 to confirm the entry.

In step S5, when the book display input screen 27 is displayed in step S4, the operator enters the mail address in the address input area 23 of the display input unit 12. Accordingly, the operator selects and enters the mail address from the address book displayed in the address book area 28. At this time, the operator can change the mail address through pushing the “Cancel” button 29. It is supposed that the operator selects a mail address “bcda@bcda.ne.jp” as an example.

In step S6, when the operator selects the “OK” button 30 after entering the mail address in step S5, the control unit 18 directs the temporary storage unit 16 to store the mail address “bcda@bcda.ne.jp”. In step S7, the control unit 18 directs the display input unit 12 to display the mail address thereon one more time in a state that the mail address “bcda@bcda.ne.jp” is input in the address input area 23.

In step S8, when the operator selects the symbol selection key 26 in step S3 after the mail address input screen 22 is displayed in step S2, the symbol control unit 21 reads the symbols recorded in the symbol storage unit 15 and displays the symbols on the display input unit 12 as the soft keyboard.

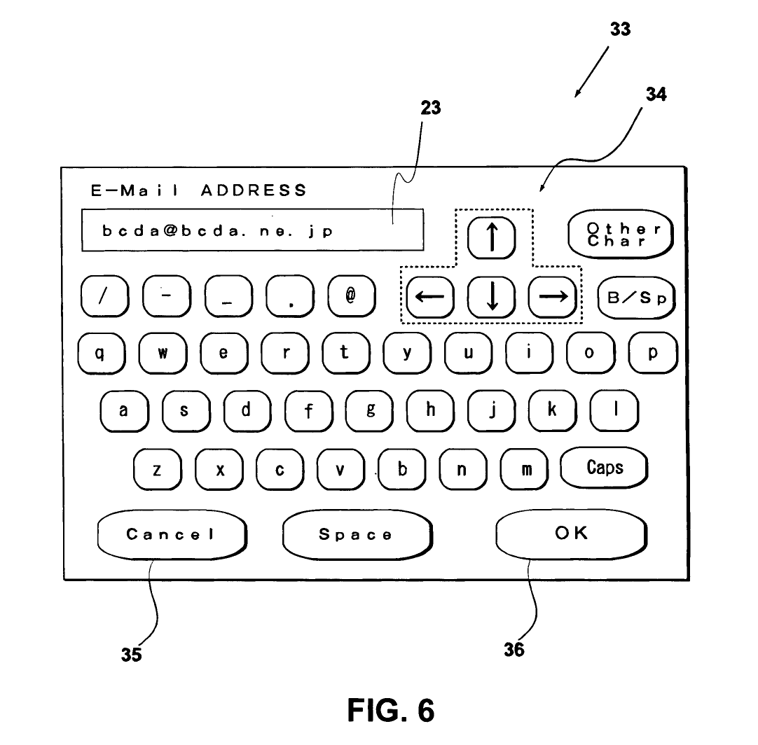

FIG. 6 is a schematic view showing a keyboard display input screen 33 according to the first embodiment of the present invention. As shown in FIG. 6, the keyboard display input screen 33 has the address input area 23 and a soft keyboard area 34. The soft keyboard area 34 displays a soft keyboard comprised of symbols, letters, and numbers, which are read out from the symbol storage unit 15. The keyboard display input screen 33 has a “Cancel” button 35 to make a correction and so on in the mail address thus entered and an “OK” button 36 to confirm the entry.

In step S9, when the keyboard display input screen 33 is displayed in step S8, the display input unit 12 directs the operator to enter a mail address in the address input area 23. Accordingly, the operator selects the symbols to enter the mail address from the soft keyboard book displayed in the soft keyboard area 34. At this time, the operator can change the mail address through pushing the “Cancel” button 35. It is supposed that the operator selects the symbols “b”, “c”, “d”, “a”, and “@” to enter the mail address “bcda@bcda.ne.jp” as an example.

In step S6, when the operator selects the “OK” button 36 after entering the mail address in step S9, the control unit 18 directs the temporary storage unit 16 to store the mail address “bcda@bcda.ne.jp”. In step S7, the control unit 18 directs the display input unit 12 to display the mail address thereon one more time in a state that the mail address “bcda@bcda.ne.jp” is input in the address input area 23.

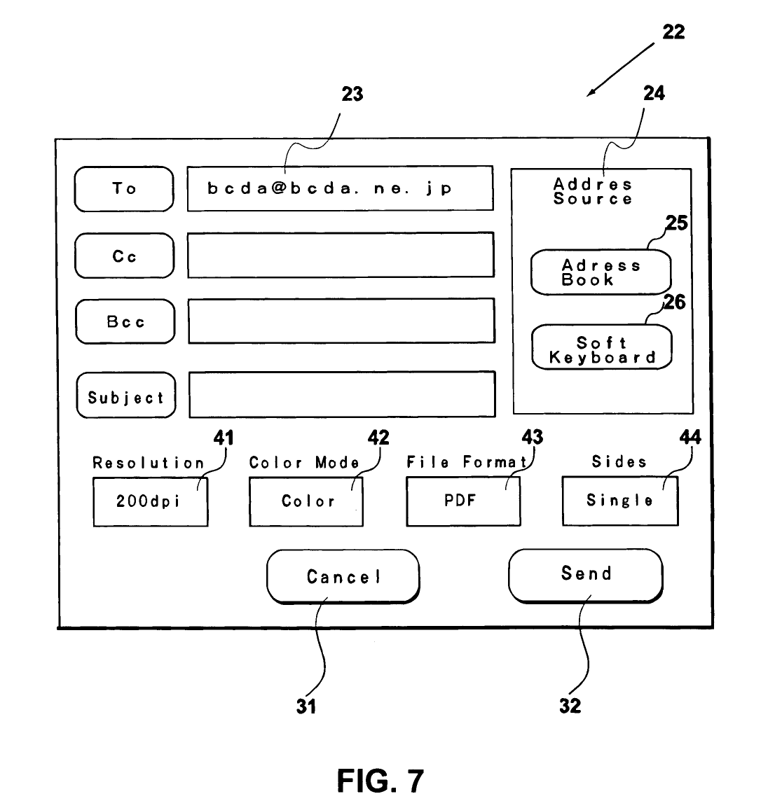

FIG. 7 is a schematic view showing the mail address input screen 22 in a state that the mail address is input according to the first embodiment of the present invention. As shown in FIG. 7, the mail address “bcda@bcda.ne.jp” is entered and displayed on the mail address input screen 22.

In step S10, the display input unit 12 displays the resolution setting area (Resolution) 41, the color mode setting area (Color Mode) 42, the file format setting area (File Format) 43, and the side setting area (Sides) 44, so that the operator sets the conditions.

In step S11, when the operator selects the “Send” button 32 while the mail address is entered as described above, the control unit 18 directs the reading unit 11 to operate. Accordingly, the reading unit 11 starts to scan the document containing an image and a text according to the conditions, and reads the information including an image and a text from the document. The information read out by the reading unit 11 is temporarily stored in the temporary storage unit 16.

When the “Send” button 32 is not selected while the mail address input screen 22 is displayed in the state that the mail address is entered, the display input unit 12 erases the mail address input screen 22 and proceeds to “Power Save Mode” after a certain period of time (e.g., 2 minutes). Further, when the “Cancel” button 31 is selected, the display input unit 12 erases the screen and proceeds to “Power Save Mode”.

In step S12, when the information is read out, the transmission unit 13 sends the information stored in the temporary storage unit 16 to the external device according to the mail address “bcda@bcda.ne.jp” stored in the temporary storage unit 16. In step S13, when the transmission of the information is completed, the confirmation determination control unit 19 displays the subsequent transmission confirmation screen on the display input unit 12 in order to determine whether there is a next transmission (i.e., subsequent transmission) to the mail address “bcda@bcda.ne.jp” after the previous transmission is completed.

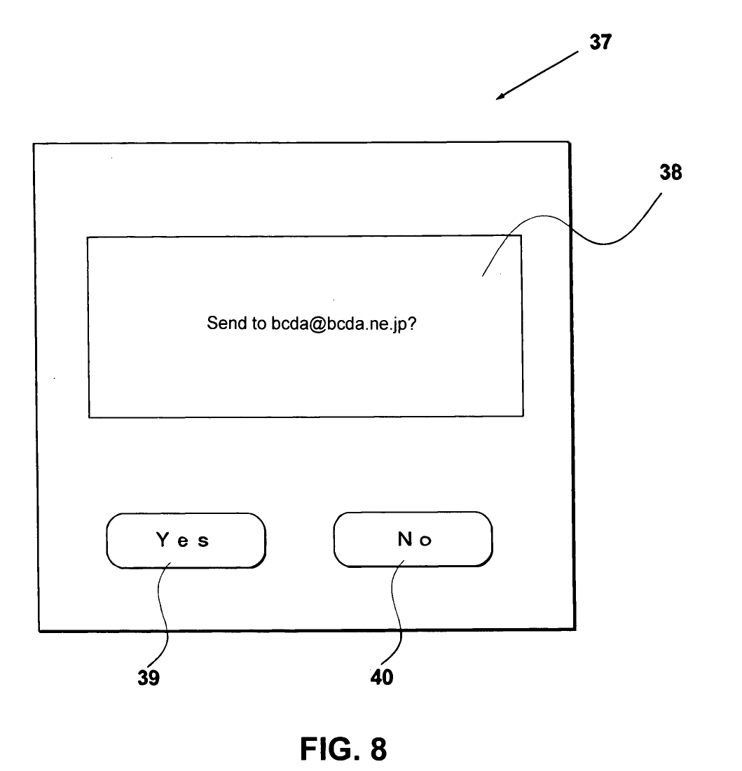

FIG. 8 is a schematic view showing the subsequent transmission confirmation screen 37 according to the first embodiment of the present invention. As shown in FIG. 8, the subsequent transmission confirmation screen 37 has a contents confirmation area 38 for the operator to confirm whether there is the subsequent transmission; a “Yes” button 39 for the operator to select the subsequent transmission to the same mail address; and a “No” button 40 for the operator not to select the subsequent transmission to the same mail address.

In the embodiment, the contents confirmation area 38 displays a message “send to the mail address “bcda@bcda.ne.jp”?” as the contents to confirm. The mail address “bcda@bcda.ne.jp” may be changed according to an entry of the operator.

In step S14, when the subsequent transmission confirmation screen 37 is displayed in step S11, the operator selects the “Yes” button 39. In step S15, the confirmation determination control unit 19 reads out the mail address “bcda@bcda.ne.jp” from the temporary storage unit 16, and keeps the mail address in the address input area 23. Further, the confirmation determination control unit 19 directs the display input unit 12 to display the mail address input screen 22. Accordingly, the mail address input screen 22 shown in FIG. 7 is displayed. At this time, the operator may change the settings.

In step S16, the control unit 18 directs the reading unit 11 to scan a next document and read information thereof, so that the information is stored in the temporary storage unit 16. Upon scanning the next document, the settings used for the previous transmission including “Resolution”, “Color Mode”, “File Format”, “Sides”, and so on may be used as the settings for the next document. The operator may change the settings using the setting keys such as “Resolution”, “Color Mode”, “File Format”, “Sides” and so on.

In step S17, the transmission unit 13 performs the subsequent transmission to the same mail address. In step S18, when the subsequent transmission confirmation screen 37 is displayed in step S13, and the operator selects the “No” button 40 in step S14, the control unit 18 directs the deletion unit 17 to delete the mail address used in the previous transmission. Accordingly, the deletion unit 17 deletes the mail address “bcda@bcda.ne.jp” from the temporary storage unit 16.

When the subsequent transmission confirmation screen 37 is displayed in step S13, and the operator does not select either of the “Yes” button 39 and the “No” button 40, the display input unit 12 erases the subsequent transmission confirmation screen 37 and proceeds to “Power Save Mode” after a certain period of time (e.g., 2 minutes).

As described above, in the first embodiment, the mail address remains for the subsequent transmission after the completion of the transmission to the same mail address. Accordingly, it is necessary to enter only one mail address for a plurality of transmissions to the mail address. As a result, the entry work by the operator can be reduced, and work hours of the operator can be also reduced. Further, when there is no subsequent transmission, it is possible to erase the destination data from the screen, thereby preventing the destination data from leaking.

### Second Embodiment

A second embodiment of the present invention will be described next. Components in the second embodiment similar to those in the first embodiment are designated by the same reference numerals, and explanations thereof are omitted.

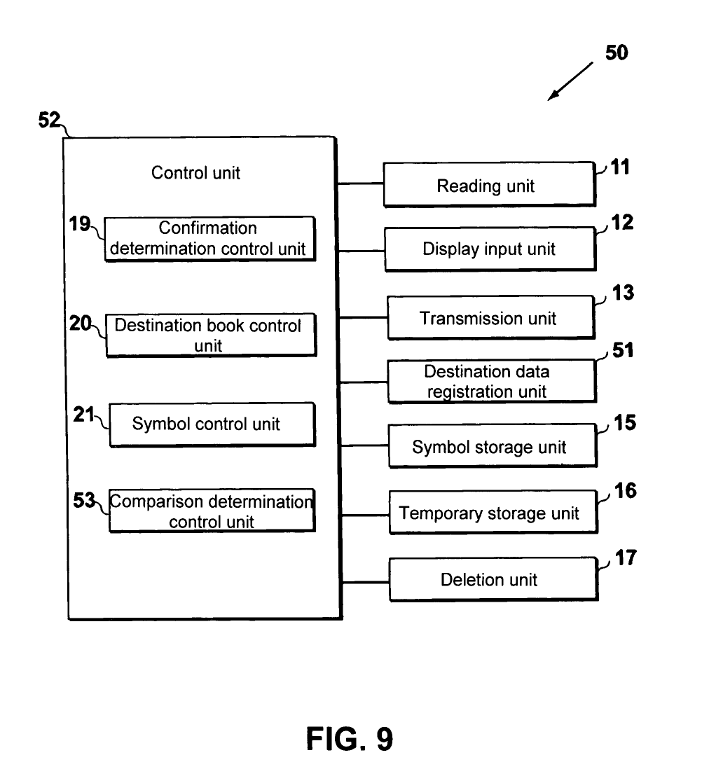

FIG. 9 is a block diagram showing an information communication device 50 according to the second embodiment of the present invention. As shown in FIG. 9, the information communication device 50 includes the reading unit 11; the display input unit 12; the transmission unit 13; a destination data registration unit 51; the symbol storage unit 15; the temporary storage unit 16; the deletion unit 17; and a control unit 52 for controlling the units described above.

In the embodiment, the destination data registration unit 51 has a function of registering destination data in advance, and registering the destination data newly entered through the display input unit 12. The control unit 52 includes a comparison determination control unit 53, in addition to the confirmation determination control unit 19, the destination book control unit 20, and the symbol control unit 21.

In the embodiment, the comparison determination control unit 53 has a function of comparing the destination data registered in the destination data registration unit 51 with the destination data newly entered through the display input unit 12. When the destination data newly entered through the display input unit 12 are same as the destination data registered in the destination data registration unit 51, the comparison determination control unit 53 directs the deletion unit 17 to operate. When the destination data newly entered through the display input unit 12 are not same as the destination data registered in the destination data registration unit 51, the comparison determination control unit 53 directs the destination data registration unit 51 to register the destination data newly entered.

An operation of the information communication device 50 according to the second embodiment of the invention will be described next. In the second embodiment, similar to the first embodiment, the mail address input screen is adopted for the transmission destination setting screen. Further, the mail addresses are adopted as the destination data, and the address book is adopted as the destination book.

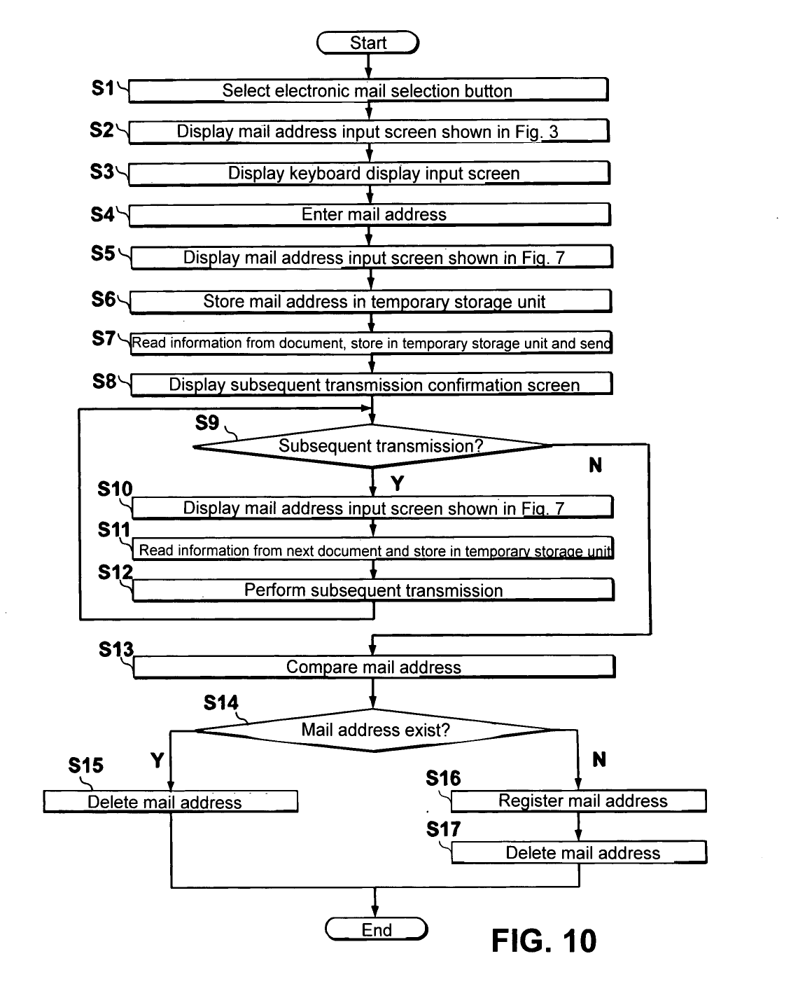

FIG. 10 is a flow chart showing the operation of the information communication device 50 according to the second embodiment of the present invention.

In step S1, the operator selects the electronic mail selection button. In step S2, the display input unit 12 displays the mail address input screen 22. In step S3, when the operator selects the symbol selection key 26, the keyboard display input screen 33 is displayed.

In step S4, the symbols are selected from the soft keyboard in the keyboard display input screen 33, and a mail address is entered. In step S5, the display input unit 12 displays the mail address input screen 22 shown in FIG. 7. It is supposed that the mail address “bcda@bcda.ne.jp” is entered as an example. At this time, the operator may set the settings described above.

In step S6, the control unit 52 stores the mail address “bcda@bcda.ne.jp” in the temporary storage unit 16. In step S7, the control unit 52 directs the reading unit 11 to read out the information from the document, and directs the temporary storage unit 16 to store the information therein. Thereafter, the transmission unit 13 sends the information to the external device according to the mail address “bcda@bcda.ne.jp”.

In step S8, when the transmission of the information is completed, the confirmation determination control unit 19 directs the display input unit 12 to display the subsequent transmission confirmation screen 37.

In step S9, the operator selects the “Yes” button 39 in the subsequent transmission confirmation screen 37. In step S10, the confirmation determination control unit 19 reads out the mail address “bcda@bcda.ne.jp” from the temporary storage unit 16, and keeps the mail address “bcda@bcda.ne.jp” in the address input area 23. Further, the confirmation determination control unit 19 displays the mail address input screen 22 shown in FIG. 7 on the display input unit 12. At this time, the operator may set the settings described above.

In step S11, the control unit 52 directs the reading unit 11 to scan the next document to read the information thereof, and directs the temporary storage unit 16 to store the information therein. In step S12, the transmission unit 13 performs the subsequent transmission according to the mail address “bcda@bcda.ne.jp”.

In step S13, when the operator selects the “No” button 40 in the subsequent transmission confirmation screen 37 (step S8) in step S9, the comparison determination control unit 53 compares the mail address “bcda@bcda.ne.jp” with the mail addresses already registered in the destination data registration unit 51.

In step S14, when it is determined that there is a mail address identical to the mail address “bcda@bcda.ne.jp” in the destination data registration unit 51, the comparison determination control unit 53 directs the deletion unit 17 to delete the mail address used in the previous transmission in step S15. More specifically, in step S15, when the mail address “bcda@bcda.ne.jp” is already registered in the destination data registration unit 51, the deletion unit 17 deletes the mail address “bcda@bcda.ne.jp” from the temporary storage unit 16.

On the other hand, when it is determined that there is no mail address identical to the mail address “bcda@bcda.ne.jp” in the destination data registration unit 51, the comparison determination control unit 53 directs the destination data registration unit 51 to register the mail address “bcda@bcda.ne.jp” used in the previous transmission in step S16. More specifically, in step S16, when the mail address “bcda@bcda.ne.jp” is not registered in the destination data registration unit 51, the destination data registration unit 51 registers the mail address “bcda@bcda.ne.jp”.

In step S17, the comparison determination control unit 53 directs the deletion unit 17 to delete the mail address “bcda@bcda.ne.jp” registered in the destination data registration unit 51 from the temporary storage unit 16.

As described above, in the second embodiment of the invention, the operator enters the mail address using the soft keyboard. After the transmission of the mail, the mail address thus entered is compared with the mail addresses registered in the destination data registration unit. When the mail address thus entered is different from the mail addresses registered in the destination data registration unit, the mail address thus entered is registered in the destination data registration unit. Therefore, when the operator uses the mail address again in the subsequent transmission, the operator can enter the mail address only by selecting from the address book using the book display input screen.

### Third Embodiment

A third embodiment of the present invention will be described next. Components in the third embodiment similar to those in the first and second embodiments are designated by the same reference numerals, and explanations thereof are omitted.

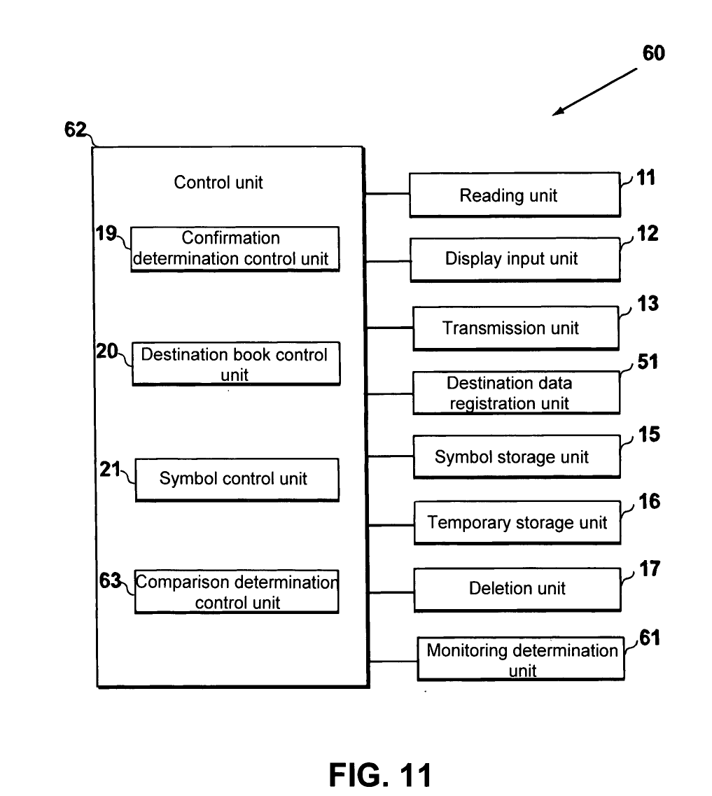

FIG. 11 is a block diagram showing an information communication device 60 according to the third embodiment of the present invention. As shown in FIG. 11, the information communication device 60 includes the reading unit 11; display input unit 12; the transmission unit 13; the destination data registration unit 51; the symbol storage unit 15; the temporary storage unit 16; the deletion unit 17; a monitoring determination unit 61, and a control unit 62 for controlling the units described above.

In the embodiment, the monitoring determination unit 61 has a function of monitoring a transmission completion status of the transmission unit 13, and for determining whether the transmission completion status is normal. The control unit 62 includes a comparison determination control unit 63, in addition to the confirmation determination control unit 19, the destination book control unit 20, and the symbol control unit 21.

In the embodiment, when the monitoring determination unit 61 determines that the transmission completion status is normal, the comparison determination control unit 63 compares the destination data newly entered with the destination data registered in the destination data registration unit 51. When it is determined that the destination data newly entered are same as the destination data registered in the destination data registration unit 51, the comparison determination control unit 63 directs the deletion unit 17 to operate.

When it is determined that the destination data newly entered are not same as the destination data registered in the destination data registration unit 51, the comparison determination control unit 63 registers the destination data newly input in the destination data registration unit 51.

In the embodiment, when the monitoring determination unit 61 determines that the transmission completion status is not normal, the control unit 62 directs the deletion unit 17 to delete the destination data newly entered from the temporary storage unit 16.

An operation of the information communication device 60 will be described next. Similar to the first embodiment and the second embodiment, in the third embodiment, the mail address input screen is adopted as the transmission destination setting screen. Further, the mail addresses is adopted as the destination data, and the address book is adopted as the destination book.

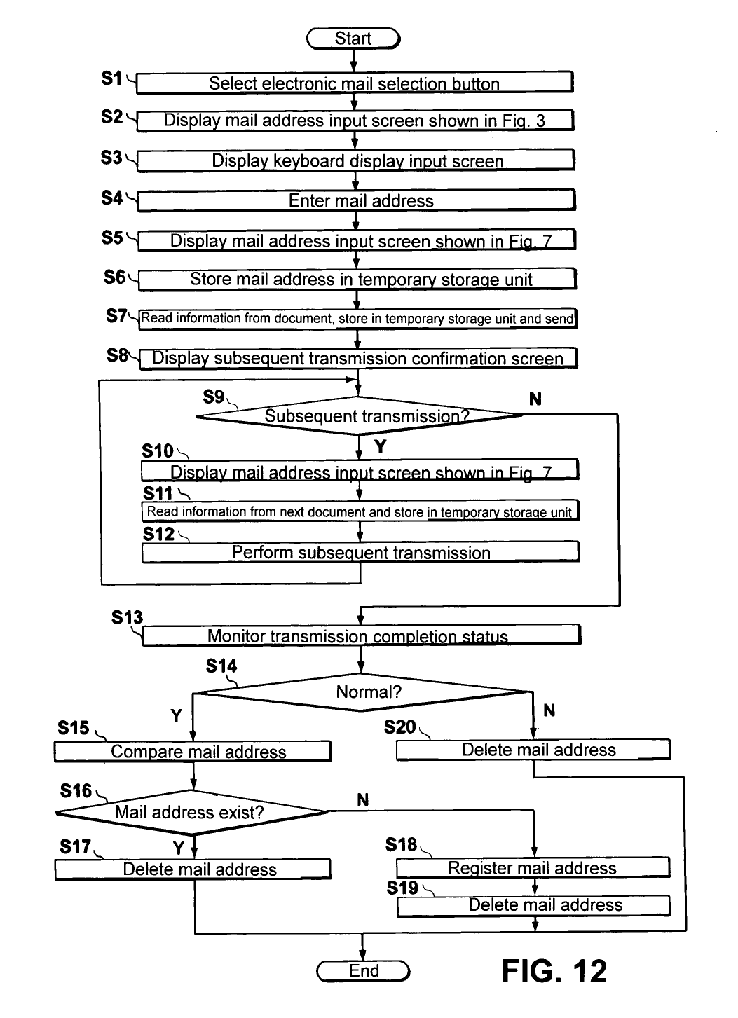

FIG. 12 is a flow chart showing the operation of the information communication device 60 according to the third embodiment of the present invention.

In step S1, the operator selects the electronic mail selection button. In step S2, the display input unit 12 displays the mail address input screen 22 shown in FIG. 3. In step S3, when the operator selects the symbol selection key 26, the keyboard display input screen 33 is displayed.

In step S4, the symbols are selected from the soft keyboard in the keyboard display input screen 33, and a mail address is entered. In step S5, the display input unit 12 displays the mail address input screen 22 shown in FIG. 7. It is supposed that the mail address “bcda@bcda.ne.jp” is entered as an example.

In step S6, the control unit 52 stores the mail address “bcda@bcda.ne.jp” in the temporary storage unit 16. In step S7, the control unit 52 directs the reading unit 11 to read out the information from the document, and directs the temporary storage unit 16 to store the information therein. Thereafter, the transmission unit 13 sends the information to the external device according to the mail address “bcda@bcda.ne.jp”.

In step S8, when the transmission of the information is completed, the confirmation determination control unit 19 directs the display input unit 12 to display the subsequent transmission confirmation screen 37.

In step S9, the operator selects the “Yes” button 39 in the subsequent transmission confirmation screen 37. In step S10, the confirmation determination control unit 19 reads out the mail address “bcda@bcda.ne.jp” from the temporary storage unit 16, and keeps the mail address “bcda@bcda.ne.jp” in the address input area 23. Further, the confirmation determination control unit 19 displays the mail address input screen 22 shown in FIG. 7 on the display input unit 12.

In step S11, the control unit 52 directs the reading unit 11 to scan the next document and read the information thereof, and directs the temporary storage unit 16 to store the information therein. In step S12, the transmission unit 13 performs the subsequent transmission according to the mail address “bcda@bcda.ne.jp”.

In step S13, when the operator selects the “No” button 40 in the subsequent transmission confirmation screen 37 (Step S8) displayed in step S9, the monitoring determination unit 61 monitors the transmission completion status of the transmission unit 13. In step S14, the monitoring determination unit 61 determines whether the transmission completion status is normal.

In step S15, when the monitoring determination unit 61 determines that the transmission completion status is normal, the comparison determination control unit 63 compares the mail address “bcda@bcda.ne.jp” with the mail addresses registered in the destination data registration unit 51.

In step S17, when the comparison determination control unit 63 determines that the mail address “bcda@bcda.ne.jp” is in the destination data registration unit 51 in step S16, the comparison determination control unit 63 directs the deletion unit 17 to delete the mail address used in the previous transmission. More specifically, in step S17, when the mail address “bcda@bcda.ne.jp” is registered in the destination data registration unit 51, the deletion 17 deletes the mail address “bcda@bcda.ne.jp” from the temporary storage unit 16.

In step S18, when the comparison determination control unit 63 determines that the mail address “bcda@bcda.ne.jp” is not in the destination data registration unit 51 in step S16, the comparison determination control unit 63 registers the mail address used in the previous transmission in the destination data registration unit 51. In other words, in step S18, when the mail address “bcda@bcda.ne.jp” is not registered in the destination data registration unit 51, the destination data registration unit 51 registers the mail address “bcda@bcda.ne.jp”.

In step S19, the comparison determination control unit 63 directs the deletion unit 17 to delete the mail address “bcda@bcda.ne.jp” registered in the destination data registration unit 51 from the temporary storage unit 16.

In step S20, when the monitoring determination unit 61 determines that the transmission completion status is abnormal in step S14, the comparison determination control unit 63 directs the deletion unit 17 to delete the mail address “bcda@bcda.ne.jp” registered in the destination data registration unit 51 from the temporary storage unit 16.

As described above, in the third embodiment of the invention, the mail address is entered using the soft keyboard. After the transmission of the mail, the transmission completion status is monitored and it is determined whether the transmission completion status is normal. When it is determined that the transmission completion status is normal, the mail address is compared. Accordingly, it is possible to always register a correct mail address in the destination data registration unit.

In the embodiments described above, the mail address is input in the address input area 23 on the mail address input screen 22, may be into other mail address entry areas such as “Cc” and “Bcc” on the mail address input screen 22. The information may include text data, image data such as a photograph, and music data. The invention can be applied not only to transmission of the electronic mails but also to facsimile transmissions according to facsimile numbers.

In the embodiments, the operator selects the electronic mail selection button “Scan To Email”, and may select other electronic mail selection buttons such as “Scan to Network” and “Scan To Mail Box”. Further, according to the transmission address, the settings for scanning the document such as “Resolution”, “Color”, “Mode”, “File Format”, and “Sides”, may be stored as a setting history and used as “default settings” of the email address. The present invention may be applied to communication devices such as a cellular phone with a camera.

The disclosure of Japanese Patent Application No. 2006-257292, filed on Sep. 22, 2006 is incorporated in the application by reference.

While the invention has been explained with reference to the specific embodiments of the invention, the explanation is illustrative and the invention is limited only by the appended claims.

What is claimed is:

1. An information communication device, comprising:
a reading unit for reading information of an original;
a display input unit for displaying a transmission destination setting screen to transmit the information, and for prompting an operator to input destination data indicating a transmission destination; and
a transmission unit for transmitting the information externally according to the destination data;
wherein said display input unit displays the destination data on the transmission destination setting screen after the transmission unit transmits the information.

2. The information communication device according to claim 1, wherein said display input unit is adapted to delete the destination data from the transmission destination setting screen after a specific period of time during a state that the display input unit displays the destination data on the transmission destination setting screen after the transmission unit transmits the information.

3. The information communication device according to claim 1, further comprising a destination data registration unit for storing the destination data, and a destination book control unit for reading the destination data registered in the destination data registration unit and displaying the destination data on the display input unit as a destination book.

4. The information communication device according to claim 1, further comprising a destination data registration unit for storing the destination data, and a symbol control unit for displaying a symbol screen including various symbols on the display input unit so that an operator can select a symbol from the symbol screen.

5. The information communication device according to claim 4, further comprising a comparison determination control unit for comparing the destination data input through the display input unit with the destination data registered in the destination data registration unit, said comparison determination control unit registering the destination data registered in the destination data registration unit when the comparison determination control unit determines that the destination data input through the display input unit are different from the destination data registered in the destination data registration unit.

6. The information communication device according to claim 5, further comprising a temporary storage unit for temporarily storing the destination data, and a deletion unit for deleting the destination data temporarily stored in the temporary storage unit when the comparison determination control unit determines that the destination data input through the display input unit are same as the destination data registered in the destination data registration unit.

7. The information communication device according to claim 4, further comprising a monitoring determination unit for monitoring a transmission completion state of the transmission unit and determining whether the transmission completion state is normal or abnormal, and a comparison determination control unit for comparing the destination data input through the display input unit with the destination data registered in the destination data registration unit when the monitoring determination unit determines that the transmission completion state is normal, said comparison determination control unit registering the destination data registered in the destination data registration unit when the comparison determination control unit determines that the destination data input through the display input unit are different from the destination data registered in the destination data registration unit.

8. The information communication device according to claim 7, further comprising a temporary storage unit for temporarily storing the destination data thus input, and a deletion unit for deleting the destination data temporarily stored in the temporary storage unit when the comparison determination control unit determines that the destination data input through the display input unit are same as the destination data registered in the destination data registration unit.

9. The information communication device according to claim 7, further comprising a temporary storage unit for temporarily storing the destination data thus input, and a deletion unit for deleting the destination data temporarily stored in the temporary storage unit when the monitoring determination unit determines that the transmission completion state is abnormal.

10. The information communication device according to claim 4, wherein said symbol control unit is arranged to display the symbol screen including a text and a graphic, said symbol screen including a keyboard display input screen.

11. The information communication device according to claim 1, wherein said display input unit is arranged to display the transmission destination setting screen including a mail address input screen so that the operator inputs the destination data including a mail address.
